(19) United States
(12) Patent Application Publication
(10) Pub. No.: US 2024/0173824 A1
(43) Pub. Date: May 30, 2024

(54) chuma-pliers

(71) Applicant: Chukwuma Marcellus Eleodimuo, Alhambra, CA (US)

(72) Inventor: Chukwuma Marcellus Eleodimuo, Alhambra, CA (US)

(21) Appl. No.: 17/974,472

(22) Filed: Nov. 30, 2022

(51) Int. Cl. B25B 7/22; B25G 1/08

(52) U.S. Cl. CPC B25B 7/22; B25G 1/08

(57) ABSTRACT

A multi-in-one plier for precise, variety types of cuttings. Different types of tools needed for precision, on point cuttings combined as one tool. Using the advantage of slide in and click in to endure easy operations, replacements and fixes, yet secured storage when handling. The pliers heads are simply fixed to their handles, coupled together with screws that in turns hold different individual rails; rails that in turns hold individual tools for both parallel and adjacent measurements and cuttings. Possible to be used combined or apart with an external handle that uses the same mechanism of slide in and click in; when more room or reach is needed.

### BACKGROUND OF THE INVENTION

A hand tool is a very vital and delicate tool that facilitates an intimate interaction between a designer and a design, a workman and a work, thereby an effectiveness of a hand tool must not only pertain to its existence but to its usage and interaction as well.

Therefore chuma-pliers, a multi-in-one hand tool for precision cuttings not only address the multiple tools and the multiple options that are needed in a designing tool, but the multiple choices and effectiveness in each of their individual usage and in the usage of them as a one tool.

### SUMMARY OF THE INVENTION

### 1. Vital Individual Designer Tools Combined as One—

Comprising of vital individual tools needed for cuttings and designing all arranged and aligned as a one design and in a one application flow

### 2. On the Spot Precision Cuttings—

Cut on the go, on the spot and on the exact point that is sure of

Comprising a ruler that is calibrated all round and in all corners, with different types of standard measurement systems. The ruler is pivoted on a rail, a rail which is secured on the side of the pliers center point, the rail can slide on the side of the pliers center point front and back when extended measurement is needed. The ruler can roll 360° and can yaw 180° enduring no effort is used when a point of cutting is locked.

Comprising a compass with an aligner. The compass is also calibrated all round with different standard measurement systems, the compass is pivoted on the tip end of the ruler, the compass can yaw 360° around the pivoted tip of the ruler and can roll 360° in uniform with the ruler, and can yaw 180° in uniform with the ruler. Making an easy use with no effort during parallel, adjacent and angular cuttings. With the aligner to endure the accurate angle is pinpointed.

Comprising a scissors and a hole puncher, another hole puncher with multiple and different sizes of round punches. Both the scissors and a hole puncher can be inserted in a fixed rail, the scissors and or the hole puncher can be slide out parallelly in a fixed point enduring no shaking and an accurate cutting and or punching is achieved in respect to the measuring tools.

The fixed plier heads slide front and back the ruler rail in parallel with the ruler and in parallel, for extended on-point cuttings or adjacent to the compass to achieve the desired cuttings with respect to a desired angle or point on the compass or the ruler respectively.

The plier heads can be fitted with different hole punching caps of different patterns for designing, cuttings and or markings. The punching caps are fitted firmly on the plier heads by sliding in and clicking-in mechanism. The punching caps aligned firmly on the plier heads and paralleled with the pliers frame enduring the same cutting actions as the fixed head of the pliers themselves during precision cuttings.

### 3. Intended Clean Cuttings/No Markings—

Only intended cuts; no markings, like inks or pre-cuts

Comprising of different varieties of cutting tools, each working directly and in harmony with a different varieties of measuring tools, the measuring tools each feature a different varieties of standard measurement systems and angles and an angle aligner, enduring that any cut on a project is an intended final cut.

### 4. Saves Determining Time—

Only use for the determined, ready, main work and cuttings

Comprising of measuring tools that is closed to the cutting edges and visible during application as to be visible during determining spot of cutting

### 5. Measuring Tool—

Comprising of different varieties of measuring tools, each measuring tool which can be detached and used independently, making use of either of the measuring tool different varieties of standard measurement systems and or angles

### 6. Balanced Grip—

Comprising fingers insertion handle and a palm balanced aligned handle respectively. The fingers insertion handle on one pair enduring variable movements of open and close during application; single or double handed. The palm balanced aligned handle enduring a maximum assertion of needed force with minimal effort and keeping the hand tool balanced to facilitate accuracy during application

### 7. External Handle—

Comprising a pair of external handles that operates without any restrictions or pivoted to the main body of the pliers or the measuring tools enduring free assertive cuttings when freestyle cuttings is needed.

### 7. Freedom in Usage—

Comprising of individual tools with a variety of choices, each tool can be easily and speedily coupled or dismantled, to be used in advantage of restrictions or independently to achieve accuracy and or freedom respectively

### 8. Eradicate Cluster, Clumsy and Misplacements—

Comprising of different vital tools that otherwise exist separately which might be misplaced or caused clumsiness or accidents due to cluster or careless placements

### 9. Cut Cost—

Comprising of vital individual tools as a one tool; all which must be present during cuttings and designing, thereby requiring having them which otherwise will in turn increase the cost of acquiring them.

### BRIEF DESCRIPTION OF THE DRAWINGS

FIG. 1—A perspective and side views of chuma-pliers, a multi-in-one hand tool for precision cuttings with all its individual tools unclipped and in the position of application

FIG. 2—A perspective and under view of a pair of a plier head with a click-in punching cap on

FIG. 2A—A perspective and under view of a pair of a plier head with a slide-in punching cap on

FIG. 3—A perspective view of a pair of a plier showing its scissors and punch slide-in holder

FIG. 4—A perspective view of the ruler and pliers rail showing the rail's inner slide-in angles and stops.

FIG. 5—A perspective view of the scissors and the punch rail showing the rail's inner slide-in angles and pliers slide-in gap

FIG. 5A—A perspective view of the scissors and the punch rail showing the rail's inner slide-in angles and pliers screw-in hole

FIG. 6—A perspective view of the ruler showing its standard measurement systems calibrations, its rail stop and its compass pivot

FIG. 7—A perspective view of the compass showing its standard measurement systems calibrations, its aligner, its pliers-scissors rail click-in hook and its ruler pivot hole

FIG. 8—A perspective view of chuma-pliers, a multi-in-one hand tool for precision cuttings with all its individual tools clipped and secured in the position of transport and or storage

FIG. 9—A perspective view showing the plier heads aligned parallelly with the ruler and the pair of scissors in position on their slide-in holders aligned adjacently with the compass respectively

FIG. 10—A perspective view of the pair of the external handles and the pair of scissors all unclipped and dismantled showing the handles and the scissors slide-in hooks and click-in button respectively

FIG. 11—A perspective view of the pair of punch with multiple and different sizes of round punches showing their click-in button, click-in hole, slide-in stop and punching hole

FIG. 12—A perspective view of the pair of external handles and the pair of punch with multiple and different sizes of round punches all assembled and clipped and in the position of application

### DETAILED DESCRIPTION OF THE INVENTION

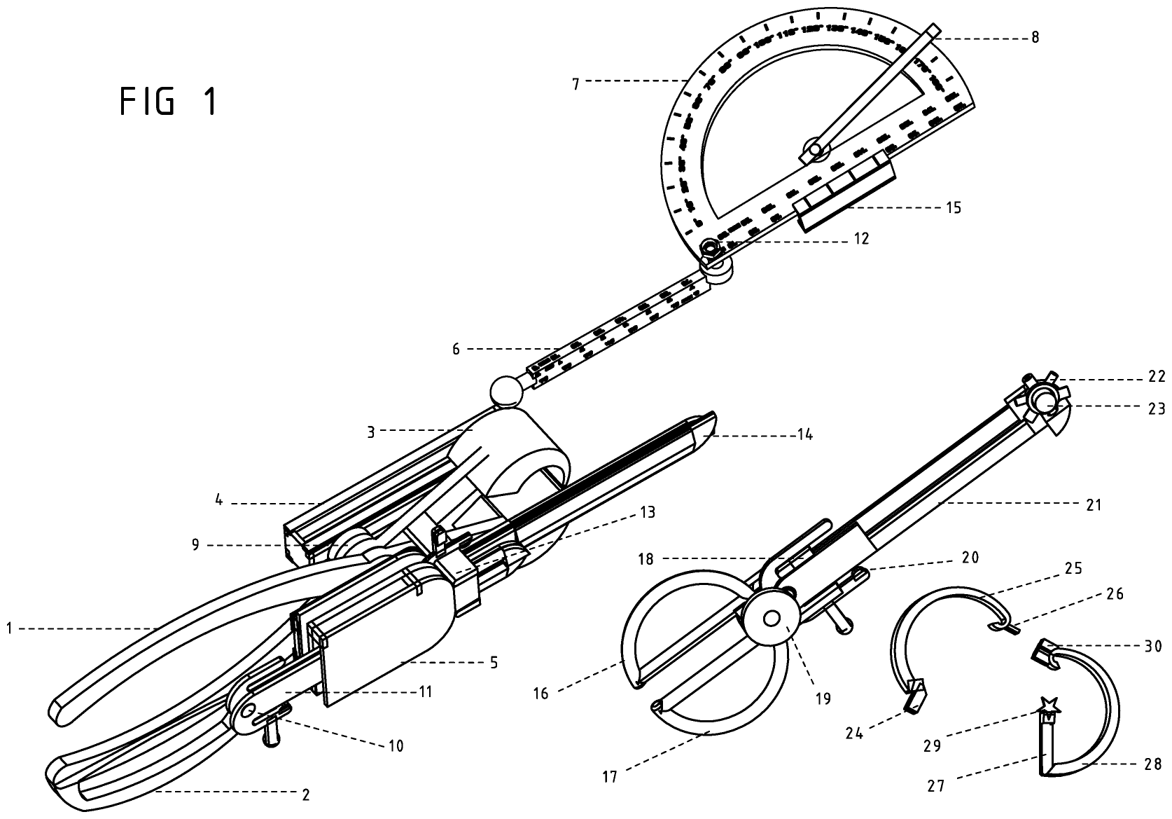

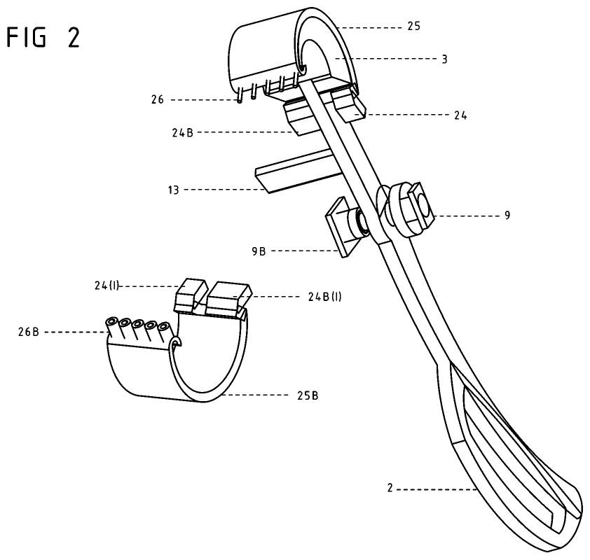

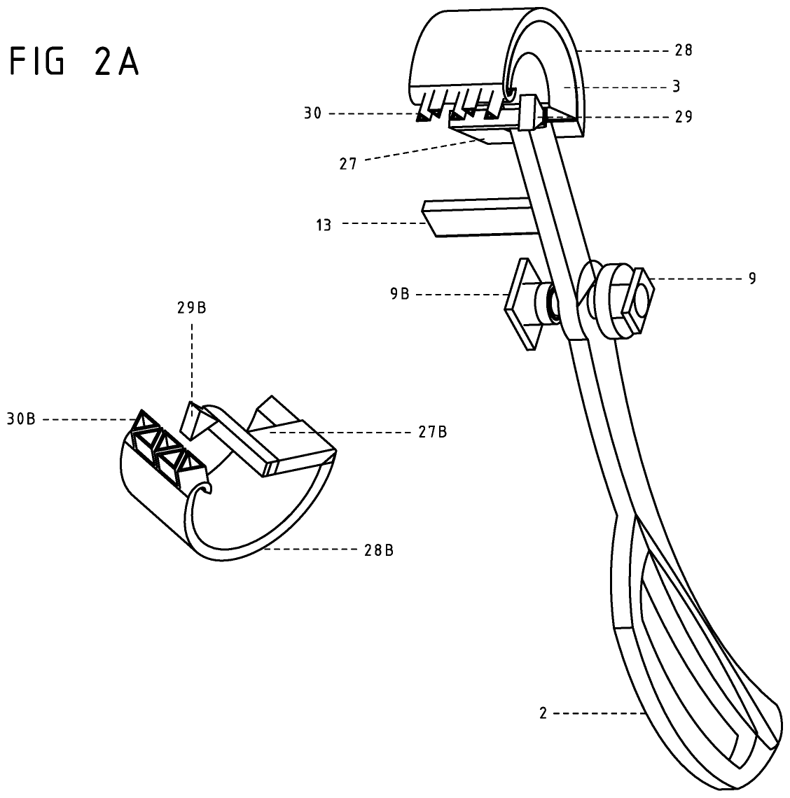

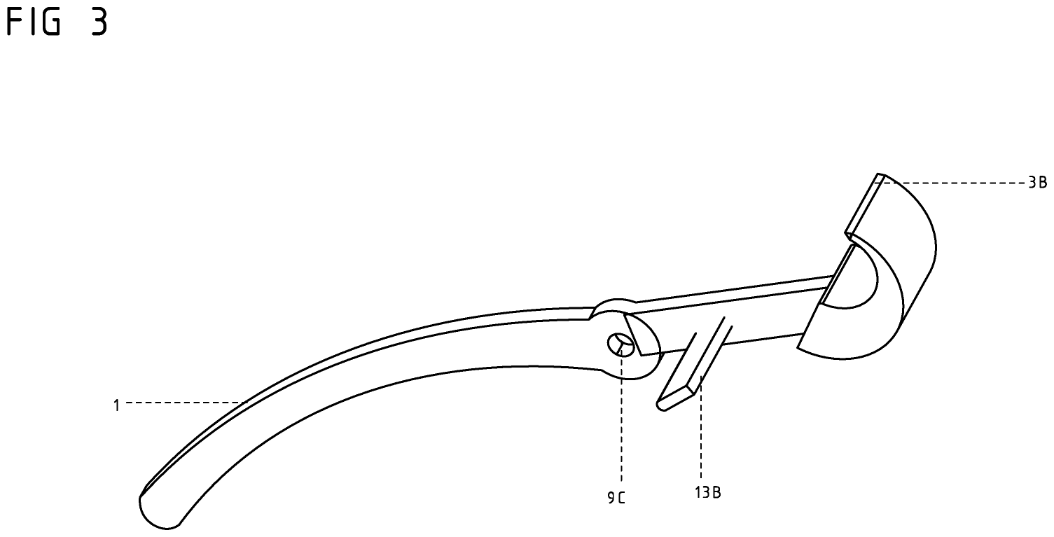

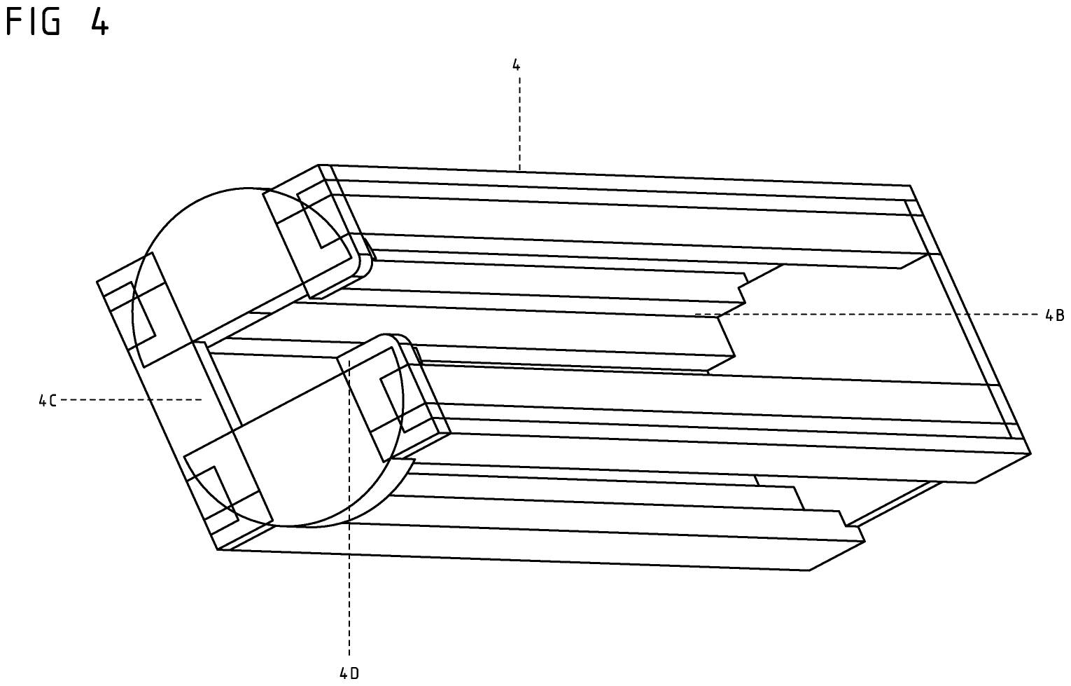

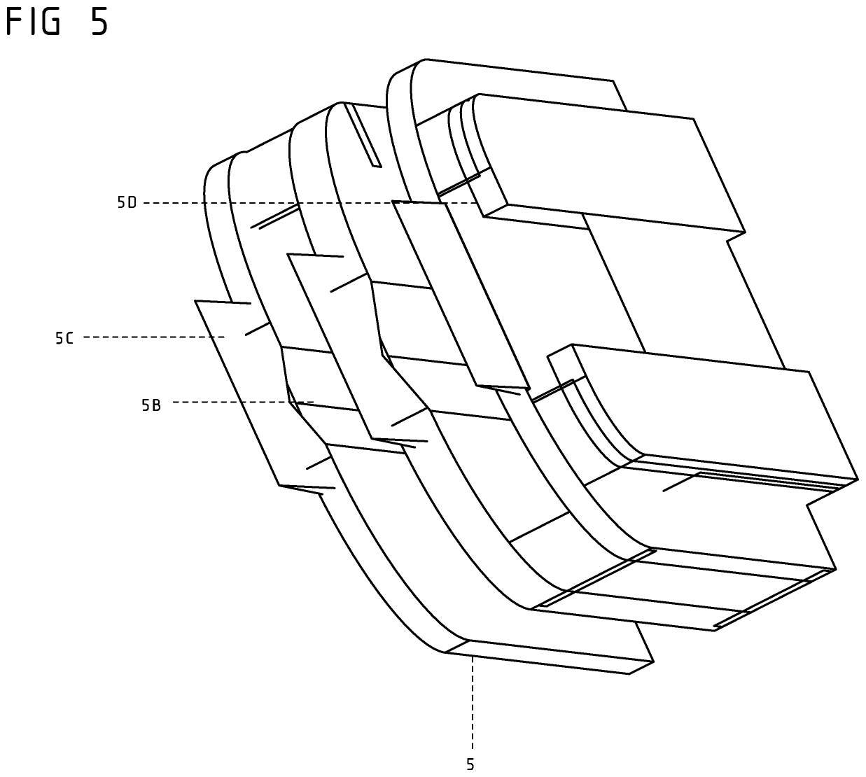

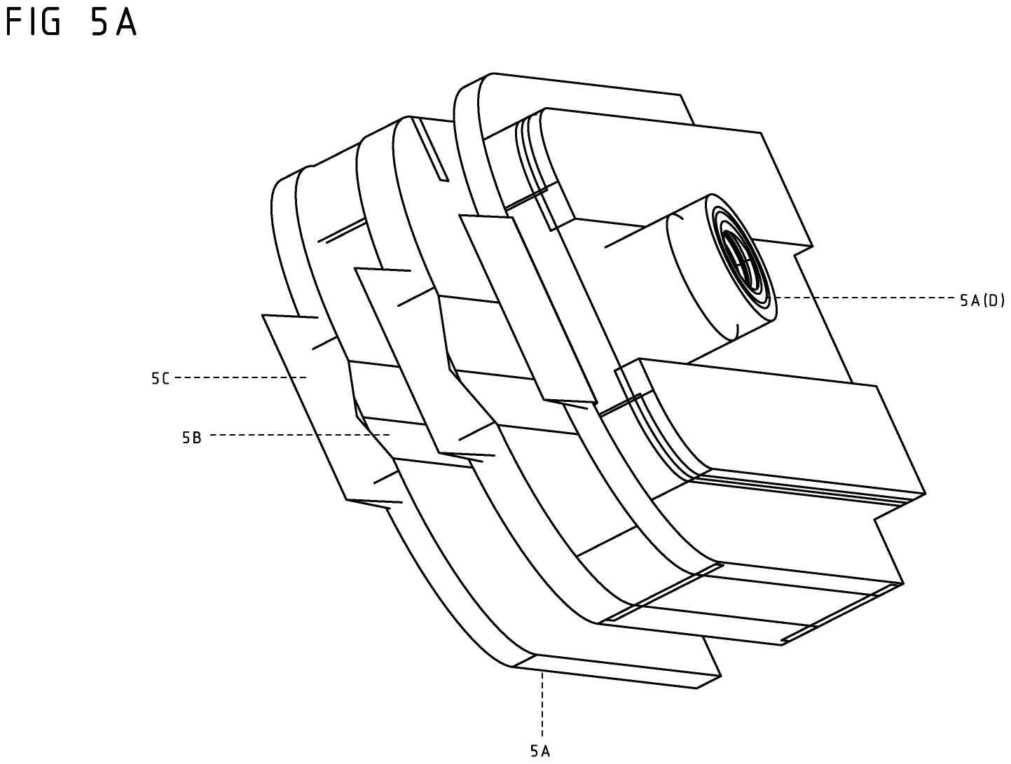

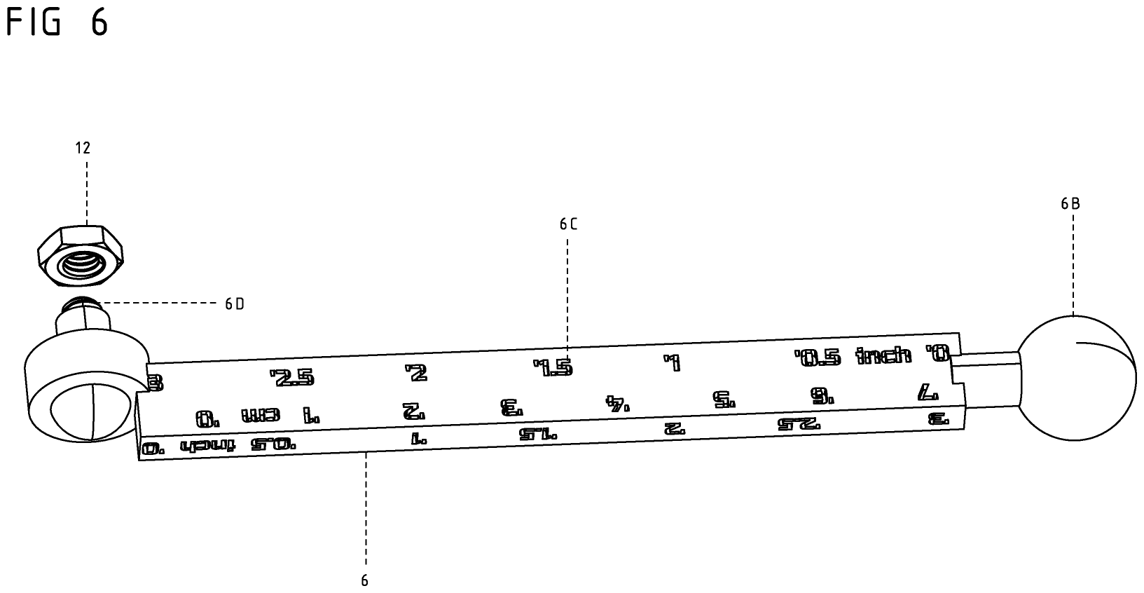

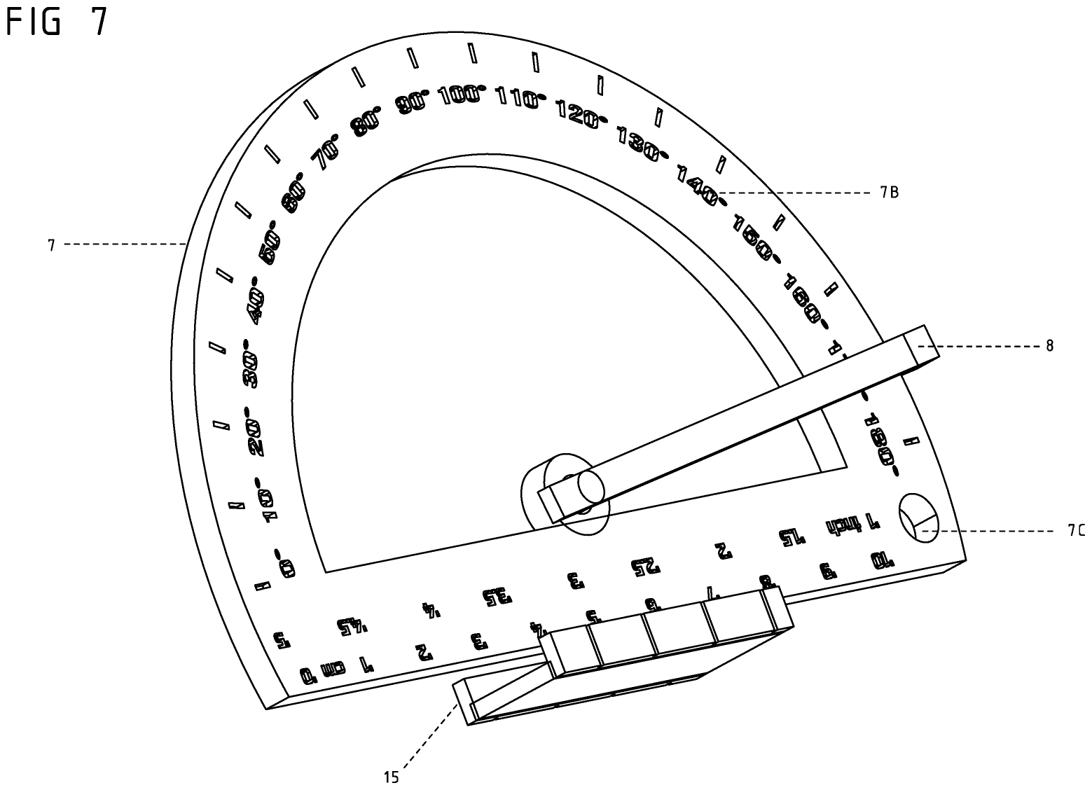

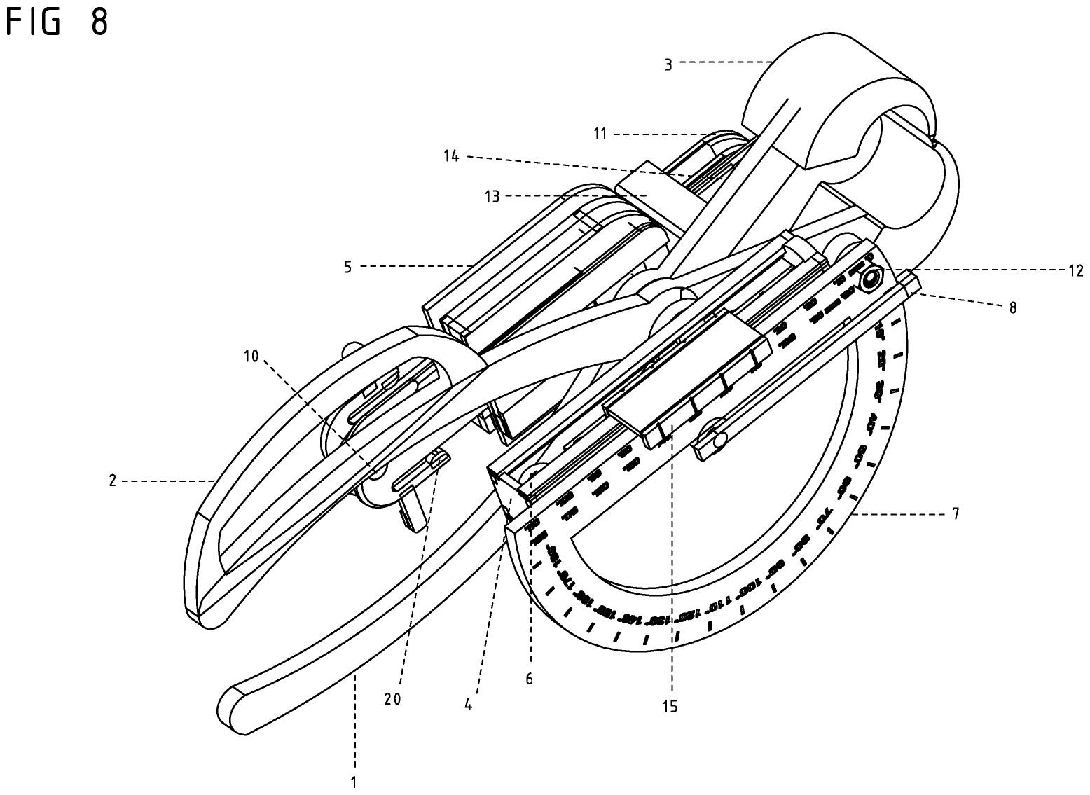

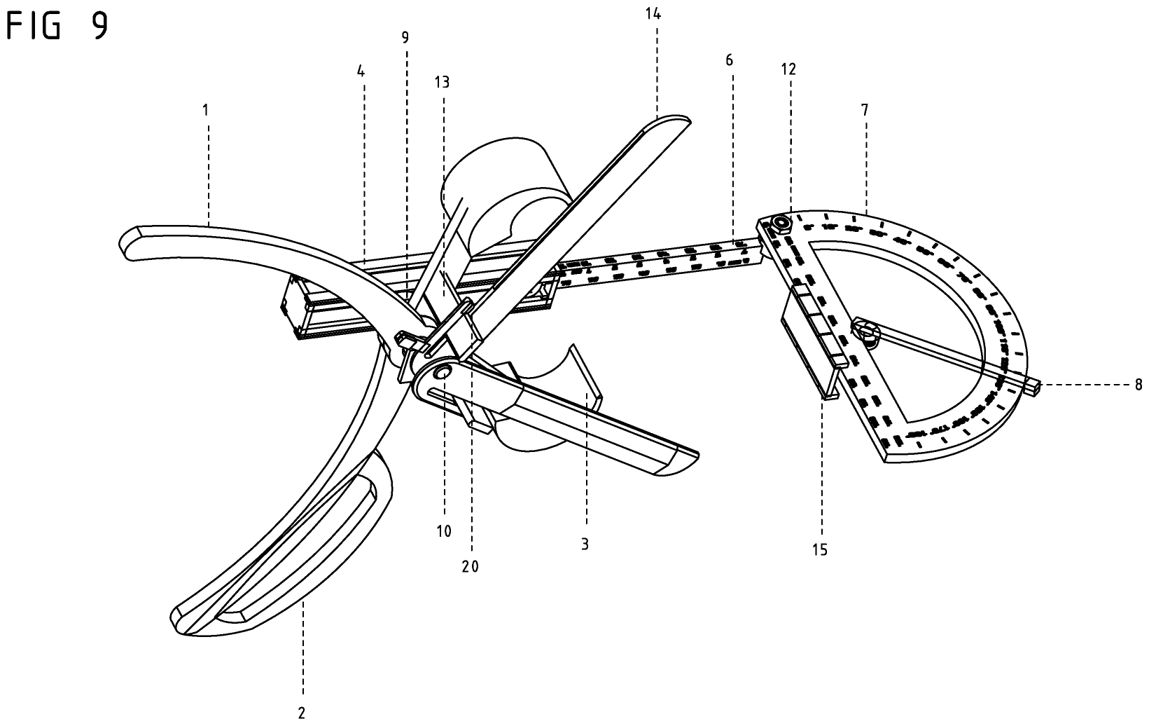

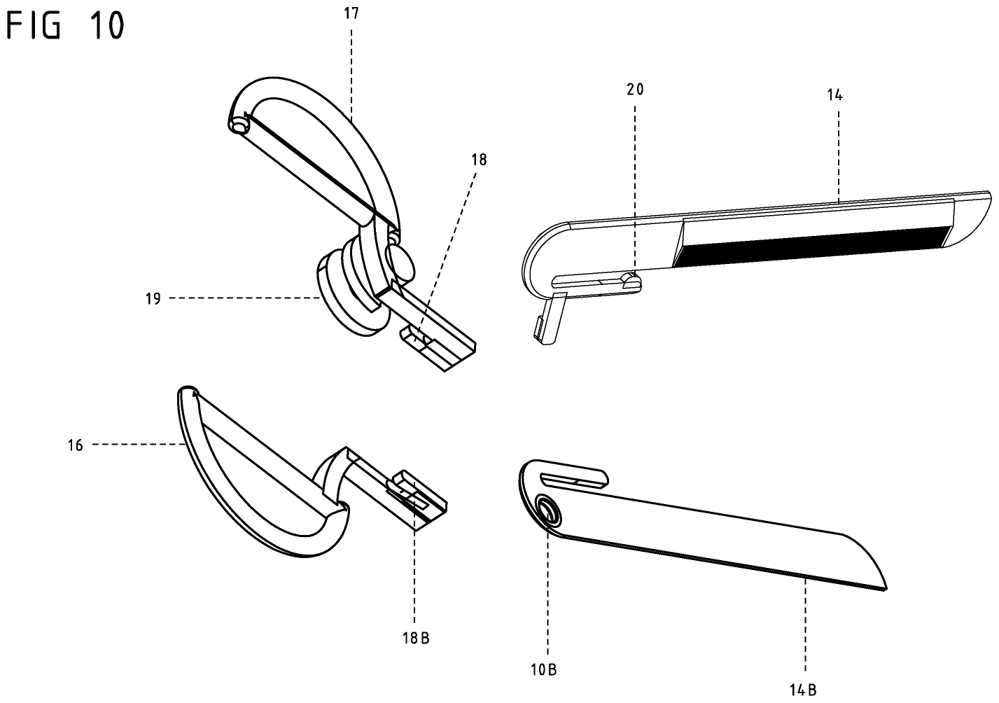

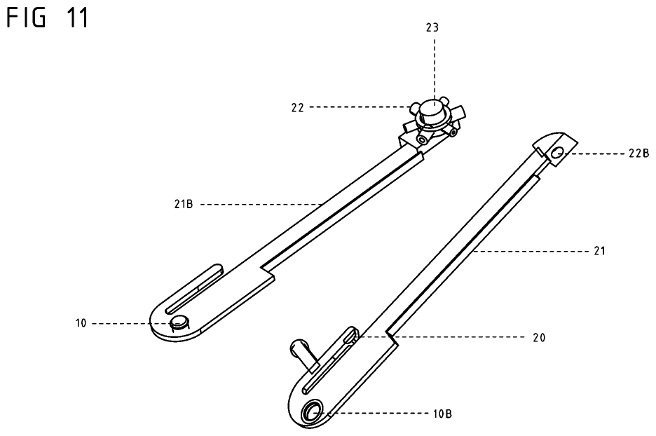

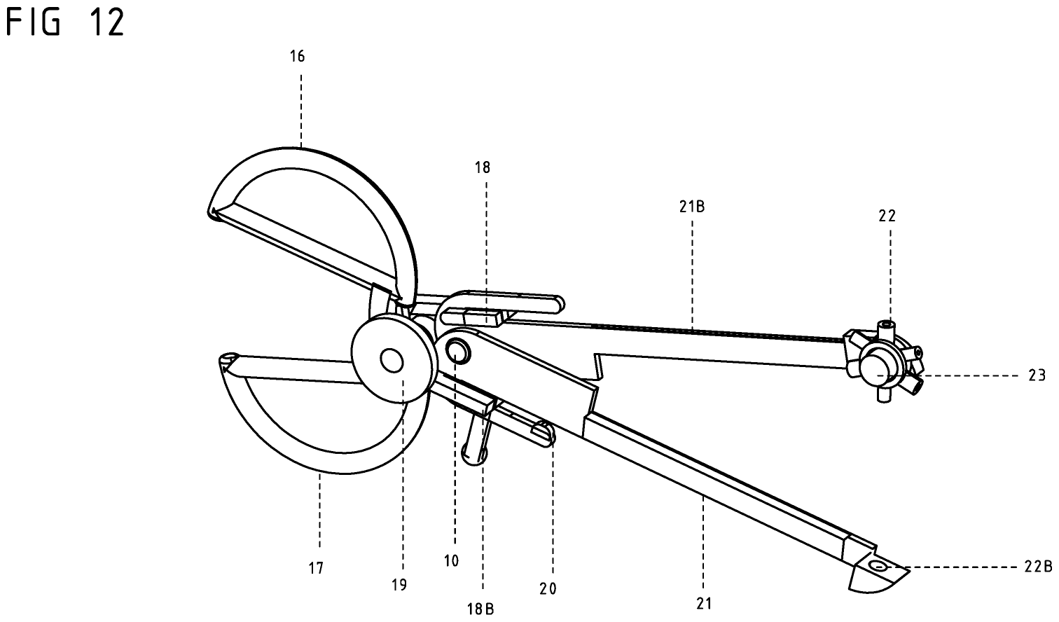

Chuma-pliers a multi-in-one hand tool for precision cuttings FIG. 1-12 is a simple hand tool designed with a designer interface and a designer interaction and workflow as shown in the interactive storage and handling in FIG. 8 all its components aligned in flow, the plier heads 3 closed and secured with all the other components clicked in place. The scissors 14 and the punch 11 in their respective slide-in angles 5B without movement or interfering with the plier heads 3, and the plier heads 3 can still be used with the scissors 14 and the punch 11 in stored position. The scissors-punch rail 5 or 5A not in the way of the plier handles 1 and 2, the scissors-punch rail 5 or 5A not in the way of the scissors-punch slide-in holders 13, rather, secured in-between the scissors-punch slide-in holders 13. The pliers handles 1 and 2 can still move and be fully used with fingers insertion handle 2 fully housing all the fingers and can be fully closed without the scissors 14 and or the punch 11 in the way. The palm balanced aligned handle 1 can still be used and can open and close with the palm balanced on it and has more room to apply all the needed force without the scissors 14 and the punch 11 or the scissors-punch rail 5 or 5A interfering or in the way of the user's hand. The pliers center screw 9 and 9B supports both the scissors-punch rail 5 or 5A with the scissors 14 and the punch 11 in place and the pliers-ruler rail 4 with the ruler 6, the pliers 3 and the compass 7 in click-in position FIG. 8; whether the pliers 3 is in use FIG. 9 or stored FIG. 8. The compass hook 15 clipped on to the pliers-ruler rail 4 with compass aligner 8 in place on its compass 7 pivot center. The ruler-compass pivot 6D as part of the ruler 6 facing outward to the side of the pliers-ruler rail 4 when stored FIG. 8; and not interfering with the ruler 6 360° roll or 180° yaw, slide-in or slide-out, during stored position FIG. 8 or in use FIG. 1 and FIG. 9, or the sliding front and back of the pliers-ruler rail 4, or the sliding front and back of the pliers in the rail angles 4B. The ruler-compass pivot 6D holds the compass 7 through the compass hole 7C which has a larger diameter enabling the compass 7 to yaw 360° and be secured on the ruler-compass pivot 6D with a screw 12 and kept in secured position during use FIG. 1 and FIG. 9 or storage FIG. 8. The ruler ball 6B is a stop that keeps the ruler in place in its pivot 4C and 4D. The ruler 6 is a parallel measuring tool against the plier heads 3 FIG. 1 and FIG. 9 and the compass 7 can be used as an extension FIG. 1 of the ruler 6 if longer area is to be measured. The compass 7 can be used as an adjacent measurement FIG. 9 against the scissors 14 and or the punch 11. The ruler-compass rail-stops 4C and 4D stops the pliers and or the ruler from sliding off and acts as the 0-point of the ruler during measurement simultaneously. The ruler-compass rail-stops 4C and 4D act as the ruler pivot during use FIG. 9. The compass aligner 8 acts as a guide to align the scissors 14 and or the punch 11 to the right angle during adjacent cuttings, markings and or measurements FIG. 9. The scissors-punch slide-in holder-stop 20 at the tip of the scissors 14 and the punch 11 slide-in handles grips onto scissors-punch slide-in holder 13 steadying and stopping the scissors 14 and or punch 11 from sliding off the holder 13 during application FIG. 9 and FIG. 1. The scissors-punch slide-in holder-stop 20 at the tip of the scissors 14 and the punch 11 slide-in handles allows the scissors 14 and or the punch 11 to open FIG. 9 wide fully in uniform with the plier heads 3 while still secure onto the scissors-punch slide-in holder 13. The scissors 14, the punch 11, the multi-size and multi-pattern punch 21B buttons 10 click-in to the button holes 10B on the scissors 14B, the punch 11, the multi-size and multi-pattern punch 21 securely and keep the scissors 14 and 14B, the punch 11, the multi-size and multi-pattern punch 21 and 21B together in pairs and functional; in use FIG. 9 or in storage FIG. 8. A single scissor 14 with a textured surface FIG. 10 serves as a sharpener for the attacking edges of the other individual cutting tools. A pair of external handles 16 and 17 is crossed and interlocked after hooking the pair of scissors 14 and 14B or the pair of punch 11 or the pair of the multi-size and multi-pattern punch 21 and 21B to their hooks 18 and 18B to serve as an unrestricted cutting tool. The pair of the external handles 16 and 17 can easily be clipped together and unclipped, to couple or dismantle with on click FIG. 10. Different pairs of punching caps 25 and 28 with different patterns and different clipping mechanisms 24 and 27 in FIG. 2 and FIG. 2B are used as repeated patterns when used to cut, by attaching the punching caps onto the plier heads 3. The clip mechanism 24 and 24B simply clipped onto either sides of a plier frame FIG. 2 and serves as a clip and an aligner simultaneously. Likewise the clip mechanism 24(I) and 24B(I) simply clipped onto either sides of a plier frame FIG. 2 and serves as a clip and an aligner simultaneously. The punch pins 26B and 30B on the punching caps 25B and 28B respectively have larger diameter than the punch pins 26 and 30 on the punching caps 25 and 28 respectively.

Therefore the patterned punch pins 26 and 30 cuts through by pushing into the patterned punch pins 26B and 30B respectively. The clip mechanism 27 and 27B act as a clip and an aligner on a plier frame FIG. 2A simultaneously. 29 and 29B are the patterned pins 30 and 30B shape indicators and push handles FIG. 2A for sliding off the punching caps 28 and 28B from the plier heads 3.

1. A multi-in-one hand tool for precision cuttings comprising of:
Multiple individual vital tools that can be assembled, disassembled and can be used as one in restrictive accuracy or use freely, fully independently all with few easy clicks.
Chuma-pliers, a multi-in-one hand tool for precision cuttings as claimed in claim 1 wherein
A rail angle, compact enough to hold a scissors securely and loose enough to let the scissors slide in and out of it during application and storage;
A rail angle, compact enough to hold a punch securely and loose enough to let the punch slide in and out of it during application and storage;
A scissors-punch rail that can be slid in and out of the pliers easily, speedily and securely;
A scissors-punch rail that can be screwed in and out of the pliers easily, speedily and securely;
A ramp slide enabling the scissors and or the punch to slide in and out of the scissors-punch rail angles respectively;
A ruler with ball stop pivoted in a rail for easy 360° rotation and 180° yaw;
A compass pivoted at the tip end of the ruler enabling to yaw 360° on the ruler pivot for measurements extension and roll 360° with the ruler and yaw 180° with the ruler for measurements extensions;
A rail with an angle to secure the ruler and the pliers to slide front and back for measurements extensions and application reach;
A pliers-ruler rail that can be slid in and out of the pliers easily, speedily and securely;
A pair of pliers aligned restrictively and confidentially to operate at the same time with the tool it's taking its measurement from, both operating as one hand tool;
A pair of pliers with scissors-punch slide-in holder that enables the scissors and or punch to open fully wide and closes completely with the pliers during application or during storage respectively;
A pair of scissors with a button and a button hole respectively, that can be easily clipped and unclipped with a click, and be used efficiently and securely while clipped;
A pair of punch with a button and a button hole respectively, that can be easily clipped and unclipped with a click, and be used efficiently and securely while clipped;
A pair of punch with multiple and different sizes of round punches with a button and a button hole respectively, that can be easily clipped and unclipped with a click, and be used efficiently and securely while clipped;
A pair of punch with multiple different sizes and different patterns of punches respectively with a button and a button hole respectively, that can be easily clipped and unclipped with a click, and be used efficiently and securely while clipped;
A pair of punch with multiple and different sizes of round punches, the different sizes of round punches which can be secured unto the punch frame with a simple screw; and easily turn for selection of the desired size, while still stayed secured on the punch frame during use;
A pair of punch with multiple different sizes and different patterns of punches respectively, the different sizes and different patterns of punches which can be secured unto the punch frame with a simple screw; and easily turn for selection of the desired size, while still stayed secured on the punch frame during use;
A pair of scissors with a slide-in holder-stop at the tip of its slide-in handle that can easily secured on the slide-in holder while the pliers open to its full capacity;
A pair of punch with a slide-in holder-stop at the tip of its slide-in handle that can easily secured on the slide-in holder while the pliers open to its full capacity;
A pair of punch with multiple and different sizes of round punches with a slide-in holder-stop at the tip of its slide-in handle that can easily secured on the slide-in holder while the pliers open to its full capacity;
A pair of punch with multiple different sizes and different patterns of punches respectively with a slide-in holder-stop at the tip of its slide-in handle that can easily secured on the slide-in holder while the pliers open to its full capacity;
A pair of external handles that can easily be coupled or dismantled with a pair of clipped scissors or a pair of clipped punches using just slide-in and click-in mechanism and be secured and fully operational during application or storage.

2. Chuma-pliers, a multi-in-one hand tool for precision cuttings comprising:
A pair of pliers with both fingers insertion handle and a palm balanced aligned handle for one hand usage and easy force application respectively;
A pair of pliers operating easily and comfortably like a scissors and a pliers at the same time;
Different types of measuring tools stored at the body of cutting tools, all as one tool;
A ruler with different types of standard measurement systems calibrated all around the surfaces;
A single scissor textured in such a way to be the sharpener for the attacking edges of the other individual cutting tools.

3. Chuma-pliers, a multi-in-one hand tool for precision cuttings comprising:
A pairs of different sizes and different patterns of punching caps respectively, that can easily be fitted onto the plier heads securely and perfectly aligned with the plier heads using just slide-in and click-in mechanism that it cuts with respect to its individual patterns and function harmoniously with the ruler and or the compass as the plier heads itself.
